(19) United States
(12) Patent Application Publication
(10) Pub. No.: US 2025/0291148 A1
(43) Pub. Date: Sep. 18, 2025

(54) LENS BARREL AND CAMERA EQUIPPED WITH SAME

(71) Applicant: Panasonic Intellectual Property Management Co., Ltd., Osaka (JP)

(72) Inventor: Takakazu BITO, Osaka (JP)

(73) Assignee: Panasonic Intellectual Property Management Co., Ltd., Osaka (JP)

(21) Appl. No.: 19/031,486

(22) Filed: Jan. 18, 2025

(30) Foreign Application Priority Data
Mar. 12, 2024 (JP) 2024-038194

(51) Int. Cl. G02B 7/04

(52) U.S. Cl. CPC G02B 7/04

(57) ABSTRACT

A lens barrel 10 includes a substantially cylindrical ring mount base 19, a plurality of lenses L1-L16, and a zoom ring 19b. The lenses L1-L16 are disposed along the optical axis direction. The zoom ring 19b changes the relative positions of the lenses L1-L16, moves the lenses L1-L16 so as to be housed inside the ring mount base 19 when not photographing, and moves at least one of the lenses L1-L16 to a position protruding in the optical axis direction from the side of the ring mount base 19 that is mounted to a camera body 50 when photographing.

### CROSS-REFERENCE TO RELATED APPLICATIONS

This application claims priority to Japanese Patent Application No. 2024-038194 filed on Mar. 12, 2024. The entire disclosure of Japanese Patent Application No. 2024-038194 is hereby incorporated herein by reference.

### BACKGROUND

### Technical Field

The present disclosure relates to a lens barrel that is used in a state of being mounted to a camera body, and a camera including this lens barrel.

### Description of the Related Art

In recent years, lens barrels mounted on cameras are made up of an optical system including a plurality of optical lenses, a drive unit for moving a frame holding the optical system in the optical axis direction, an aperture unit, and so forth.

For example, Patent Literature 1 discloses an interchangeable lens barrel comprising a fixed frame that is formed in an annular shape and is longer in the optical axis direction, a rectilinear frame that moves relative to the annular fixed frame in the optical axis direction, is housed in the fixed frame when not photographing, and is deployed to the outside of the fixed frame in a photography state, and a first annular member that is placed on the rectilinear frame, is longer in the optical axis direction, and is turned around the optical axis by manual operation, wherein when the lens barrel is in a state that allows photography, at least a part of the outer periphery of the first annular member is exposed to the outside, and the front end face of the annular member at the front of the optical axis is located ahead of the front end face of the fixed frame at the front of the optical axis, and when the lens barrel is in a state that does not allow photography, in which the lens barrel has been shortened in the optical axis direction from the photography state, the rear end face behind the optical axis is within the fixed frame and is located further to the rear of the optical axis than when the rear end face is in a state that allows photography.

### CITATION LIST

### Patent Literature

Patent Literature 1: PCT International Publication No. WO 2014/115760

### SUMMARY

### Problem to be Solved by the Invention

However, the following problem is encountered with the conventional interchangeable lens barrel discussed above.

That is, with the interchangeable lens barrel disclosed in the above publication, photography is performed by moving the lens so as to protrude closer to the subject side in a taking photography compared with a retracted state.

Accordingly, when an adapter is inserted between the lens barrel and the camera body to allow mounting to a camera body with different specifications, such as a full-size camera body or a Micro Four Thirds system, for example, a problem was that the size in the optical axis direction during photography ended up being larger by the thickness of the adapter.

It is an object of the present disclosure to provide a lens barrel with which an adapter compatible with camera bodies of different specifications can be mounted without increasing the size in the optical axis direction during photography, as well as a camera equipped with this lens barrel.

### Means for Solving Problem

The lens barrel according to the present disclosure is a lens barrel that is used in a state of being mounted to a camera body, and in which the relative positions of a plurality of lenses are different when photographing and when not photographing, the lens barrel including a substantially cylindrical main body part, a plurality of lenses, and a drive unit. The lenses are disposed along the optical axis direction. The drive unit changes the relative positions of the lenses, moves the lenses so that they are housed inside the main body part when not photographing, and moves at least one of the lenses to a position protruding in the optical axis direction from the side of the main body part that is mounted to the camera body when photographing.

### Effects

With the lens barrel according to the present disclosure, an adapter compatible with camera bodies of different specifications can be mounted without increasing the size in the optical axis direction during photography.

### BRIEF DESCRIPTION OF THE DRAWINGS

FIG. 1 is a cross-sectional view of the configuration of the lens barrel according to an embodiment of the present disclosure in a retracted state;

FIG. 2 is a cross-sectional view of the configuration of the lens barrel in FIG. 1 at the WIDE position;

FIG. 3A is a cross-sectional view of the configuration of an FF adapter that is mounted to a mounting portion of the lens barrel in FIG. 2;

FIG. 3B is a cross-sectional view of the configuration of an MFTS adapter that is mounted to a mounting portion of the lens barrel in FIG. 2;

FIG. 4A is a schematic diagram of the configuration when retracted (when not photographing) with an FF adapter or an MFTS adapter mounted between the lens barrel and the camera body in FIG. 2;

FIG. 4B is a schematic diagram of the configuration during photography in a state in which an FF adapter or an MFTS adapter is mounted between the lens barrel and the camera body in FIG. 2;

FIG. 5 is a cross-sectional view of the state when an FF adapter has been mounted to the lens barrel in FIG. 2;

FIG. 6 is a cross-sectional view of the state when the lens barrel in FIG. 5 has been moved to the TELE position;

FIG. 7 is a cross-sectional view of the state when an MFTS adapter has been mounted to the lens barrel in FIG. 2;

FIG. 8 is a cross-sectional view of the state when the lens barrel in FIG. 7 has been moved to the TELE position; and

FIG. 9 is a graph of the relation between the zoom rotation angle and the zoom movement amount of each lens group, as an example of the design of cam grooves of a cam cylinder included in the lens barrel of FIG. 2.

### DETAILED DESCRIPTION OF THE EMBODIMENT

Embodiments will now be described in detail with reference to the drawings as appropriate. However, some unnecessarily detailed description may be omitted. For example, detailed description of already known facts or redundant description of components that are substantially the same may be omitted. This is to avoid unnecessary repetition in the following description, and facilitate an understanding on the part of a person skilled in the art.

The applicant has provided the appended drawings and the following description so that a person skilled in the art might fully understand this disclosure, but does not intend for these to limit what is discussed in the patent claims.

### Embodiment 1

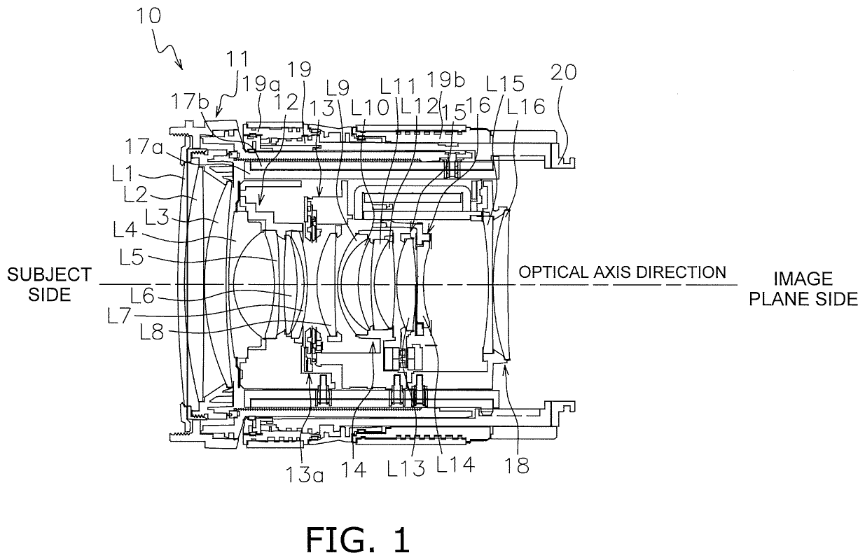

A lens barrel 10 according to an embodiment of the present disclosure and a camera 100 including this lens barrel will now be described with reference to FIGS. 1 to 9.

### (1) Overall Configuration of Lens Barrel 10

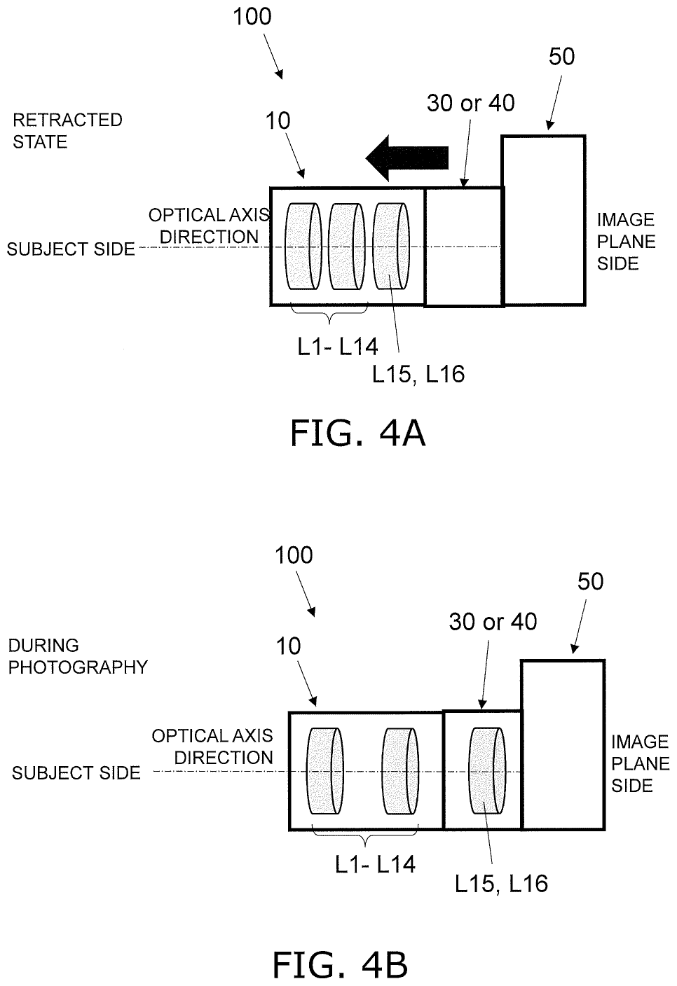

The lens barrel 10 according to this embodiment is mounted to a mounting portion on the camera body 50 side in a state of being able to be attached to and detached from the camera body 50 (see FIG. 4A, etc.). As shown in FIG. 1, adapters 30 and 40 (discussed below) can be attached to and detached from the lens barrel 10, and the lens barrel 10 is mounted to the mounting portion of the camera body 50 in a state in which the adapter 30 or 40 has been mounted, and this constitutes a camera 100 (see FIG. 4A, etc.). The lens barrel 10 has an optical system (lenses L1 to L16) that guides a subject image to an imaging element (not shown) provided on the camera body 50 side.

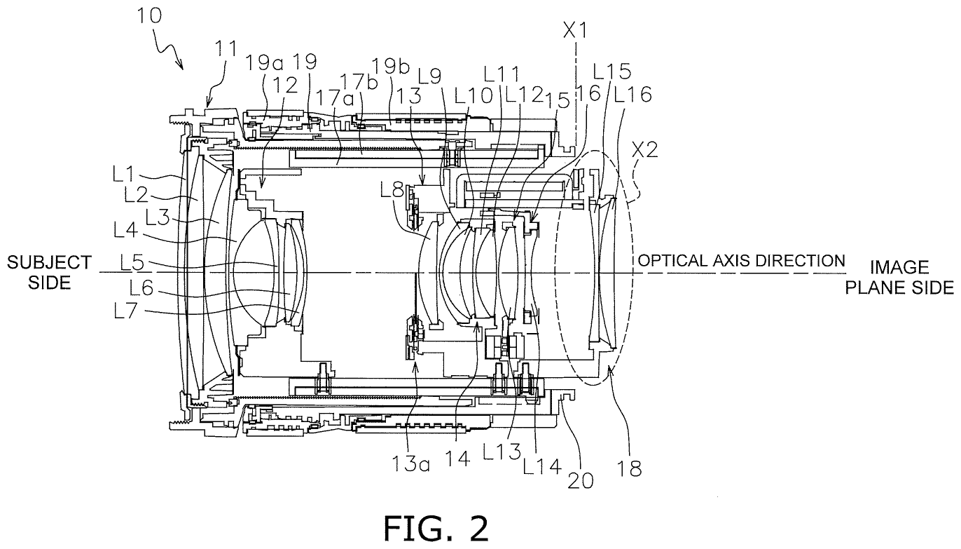

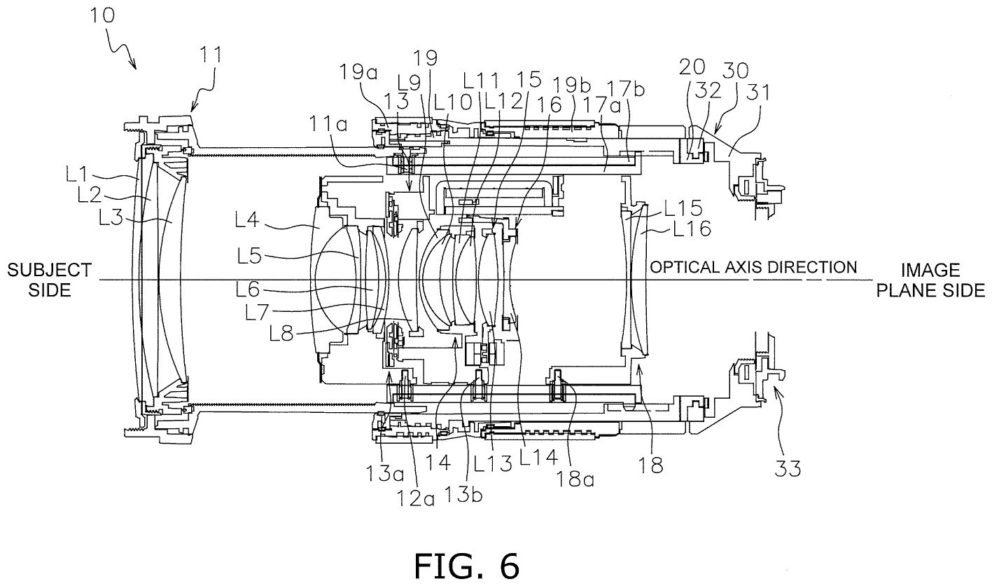

Also, the lens barrel 10 is capable of variable magnification photography by moving the built-in optical system between the wide-angle side (WIDE side position) shown in FIG. 2 and the telephoto side (TELE side position) shown in FIG. 6 (discussed below).

When the lens barrel 10 is in the WIDE position shown in FIG. 2, the first lens group unit 11 is housed on the inner peripheral surface side of the ring mount base 19 (main body part).

On the other hand, when the lens barrel 10 is in the TELE side position (see FIG. 6), the first lens group unit 11 advances to the subject side in the optical axis direction and protrudes from the lens mount 20 toward the subject.

Also, when the lens barrel 10 of this embodiment is in the retracted position shown in FIG. 1 (when not photographing), all of the lenses L1 to L16 included in the lens barrel 10 are disposed at positions closer to the subject side in the optical axis direction within the ring mount base 19. On the other hand, when the lens barrel 10 is in the WIDE position shown in FIG. 2 (when in use), the lenses L15 and L16 disposed on the image plane side form a protruding portion X2 that protrudes from the end X1 of the lens barrel 10 toward the image plane side.

Here, in the retracted state shown in FIG. 1, the length of the lens barrel 10 in the optical axis direction is invariable, and the lenses L1 to L16 are disposed at positions closer to the subject side within the ring mount base 19.

As shown in FIGS. 1 and 2, the lens barrel 10 includes an optical system made up of a first lens group unit 11, a second lens group unit 12, a 3a-th lens group unit 13, a 3b-th lens group unit 14, a 3c-th lens group unit 15, a fourth lens group unit 16, a rectilinear cylinder 17a, a cam cylinder 17b, a fifth lens group unit 18, a ring mount base 19, a focus ring 19a, a zoom ring 19b (manual operation ring), a lens mount 20, and a plurality of lenses L1 to L16.

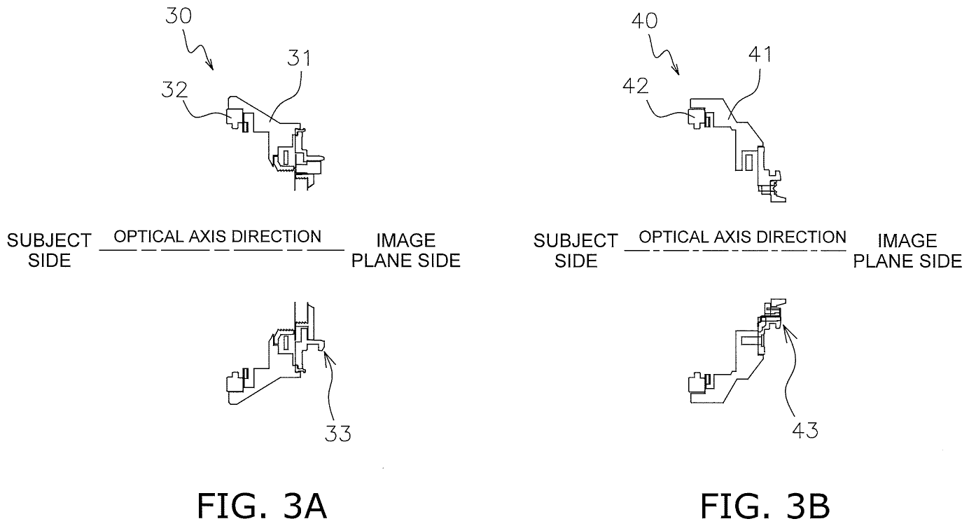

In the lens barrel 10 of this embodiment, an adapter (full-size frame (FF) adapter 30 (see FIG. 3A) or a Micro Four Thirds system (MFTS) adapter 40 (see FIG. 3B)) is mounted between the ends of the lenses L1 to L16 on the opposite side from the subject side in the optical axis direction (the lens mount 20 side, the image plane side) and the camera body 50.

That is, in this embodiment, as shown in FIG. 4A, an adapter (FF adapter 30 (see FIG. 3A) or MFTS adapter 40 (see FIG. 3B)) is inserted and attached between the image plane side of lens barrel 10 and the camera body 50 to constitute the camera 100. That is, as shown in FIGS. 4A and 4B, the camera 100 in this embodiment includes the lens barrel 10, an adapter (FF adapter 30 or MFTS adapter 40), and the camera body 50.

Consequently, even if the camera body 50 is not configured to be compatible with the connection portion (lens mount 20) on the lens barrel 10 side, the lens barrel 10 can still be mounted to the camera body 50 by inserting and attaching a suitable adapter.

Here, with the lens barrel 10 of this embodiment, in the retracted state shown in FIG. 4A (when not photographing), all of the lenses L1 to L16 are disposed on the inner peripheral side of the lens barrel 10. On the other hand, when photographing (when in use) as shown in FIG. 4B, the zoom ring 19b is turned so that the lenses L15 and L16 disposed closest to the image plane in the optical axis direction advance to a position protruding from the end of the lens barrel 10 on the image plane side. At this point, the protruding lenses L15 and L16 are contained within the adapter (FF adapter 30 or MFTS adapter 40) as shown in FIG. 4B.

As shown in FIGS. 4A and 4B, the length of lens barrel 10 of this embodiment in the optical axis direction remains unchanged when retracted (not photographing) and when photographing (when in use).

This allows a suitable adapter (FF adapter 30 or MFTS adapter 40) to be attached according to the specifications of the camera body 50, without having to increase the length of the lens barrel 10 in the optical axis direction during photography.

The first lens group unit 11 is a substantially cylindrical member disposed closest to the subject in the lens barrel 10. As shown in FIGS. 2A and 2B, the first lens group unit 11 moves forward and backward in the optical axis direction when the manual operation ring (zoom ring 19b) is turned in a state in which the lenses L1 to L3 are held on the subject side. This changes the distance between the lenses L1 to L16, allowing wide-angle and telephoto photography to be performed.

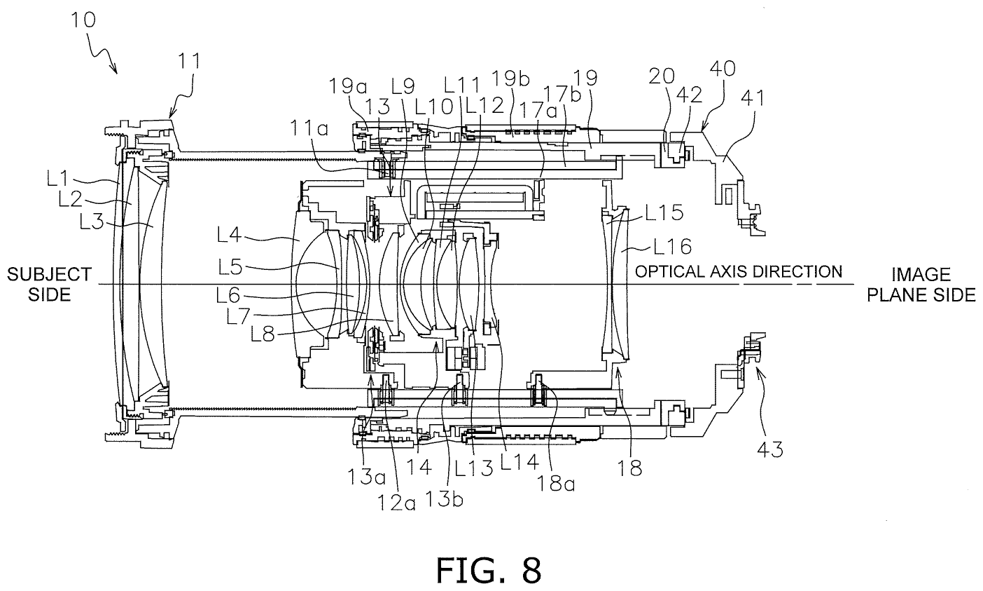

The first lens group unit 11 is mounted on the inner peripheral surface side of the ring mount base 19 in a state of enveloping the second to fifth lens group units 12 to 18, the rectilinear cylinder 17a, and the cam cylinder 17b. The first lens group unit 11 further has a cam pin 11a (see FIGS. 6 and 8).

The cam pin 11a engages with a rectilinear groove in the rectilinear cylinder 17a. This restricts movement of the first lens group unit 11 in the rotational direction, limiting the movement to the optical axis direction.

Also, the cam pin 11a engages with a cam groove in the cam cylinder 17b. Consequently, the position of the first lens group unit 11 in the optical axis direction is determined by the position of engagement with the cam groove, and movement to zoom positions such as the retracted position, WIDE position, or TELE position is accomplished by turning the cam cylinder 17b.

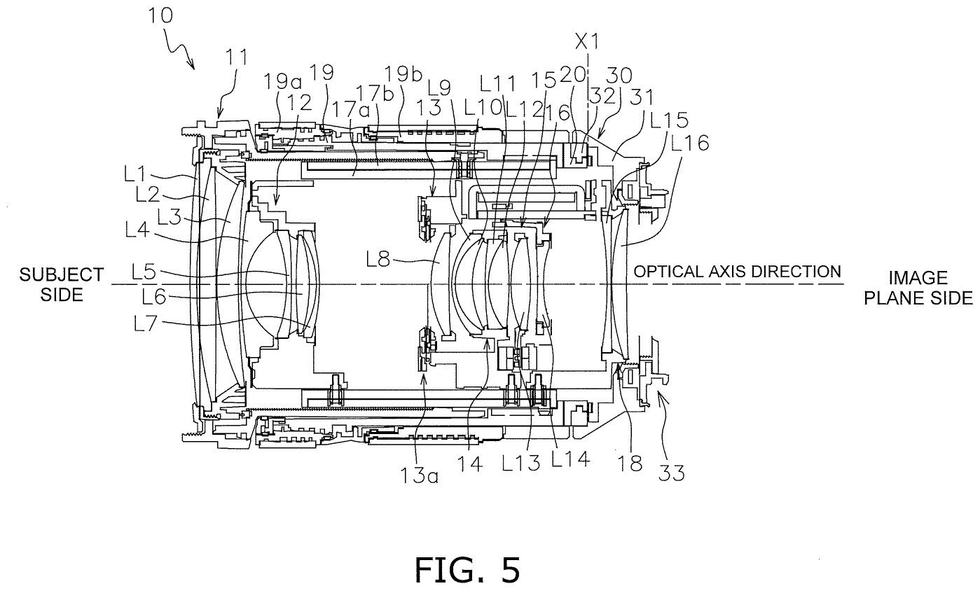

As shown in FIGS. 1 and 2, the second lens group unit 12 is a substantially cylindrical member that is disposed on the inner peripheral surface side of the first lens group unit 11, and holds the lenses L4 to L7. The second lens group unit 12 moves forward and backward in the optical axis direction when the manual operation ring (zoom ring 19b) is turned, for example (see FIGS. 5 and 6, etc.). The second lens group unit 12 further has a cam pin 12a (see FIGS. 6 and 8).

The cam pin 12a engages with a rectilinear groove in the rectilinear cylinder 17a. Consequently, movement of the second lens group unit 12 is restricted to the rotational direction, limiting movement to the optical axis, as is the case with the first lens group unit 11.

Also, the cam pin 12a engages with a cam groove in the cam cylinder 17b. Consequently, the position of the second lens group unit 12 in the optical axis direction is determined by the position of engagement with the cam groove, and the second lens group unit 12 moves to zoom positions such as the retracted position, WIDE position, or TELE position, when the cam cylinder 17b is turned, as is the case with the first lens group unit 11.

As shown in FIG. 1, the 3a-th lens group unit 13 is a substantially cylindrical member that is disposed on the inner peripheral surface side of the first lens group unit 11, and is disposed on the image plane side of the second lens group unit 12 in the optical axis direction. As shown in FIGS. 1 and 2, the 3a-th lens group unit 13 holds the lens L8, and has an aperture unit 13a provided on the subject side of the lens L8. The 3a-th lens group unit 13 moves forward and backward in the optical axis direction when the manual operation ring (zoom ring 19b) is turned, for example. The 3a-th lens group unit 13 further has a cam pin 13b (see FIGS. 6 and 8).

The cam pin 13b engages with a rectilinear groove in the rectilinear cylinder 17a. Consequently, movement of the 3a-th lens group unit 13 is restricted in the rotational direction, limiting movement to the optical axis direction, as is the case with the first lens group unit 11 and the second lens group unit 12.

Also, the cam pin 13b engages with a cam groove in the cam cylinder 17b. Consequently, the position of the 3a-th lens group unit 13 in the optical axis direction is determined by the position of engagement with the cam groove, and the 3a-th lens group unit 13 moves to the zoom positions such as the retracted position, WIDE position, or TELE position when the cam cylinder 17b is turned, as is the case with the first lens group unit 11 and the second lens group unit 12.

The aperture unit 13a is a substantially annular member, and adjusts the amount of light passing through the lens portion of the lens barrel 10 by driving movable blades to vary the surface area of the open portion.

The 3b-th lens group unit 14 is a substantially cylindrical member that is disposed on the inner peripheral surface side of the first lens group unit 11, and is disposed on the image plane side of the 3a-th lens group unit 13 in the optical axis direction. The 3b-th lens group unit 14 holds the lenses L9 to L12, as shown in FIGS. 1 and 2. The 3b-th lens group unit 14 moves forward and backward in the optical axis direction by when the manual operation ring (zoom ring 19b) is turned, for example.

The 3c-th lens group unit 15 is a substantially disk-shaped member that is disposed on the inner peripheral surface side of the first lens group unit 11, and is disposed on the image plane side of the 3b-th lens group unit 14 in the optical axis direction. The 3c-th lens group unit 15 holds the lens L13, as shown in FIGS. 1 and 2, etc. The 3c-th lens group unit 15 moves forward and backward in the optical axis direction when the manual operation ring (zoom ring 19b) is turned, for example.

With the lens barrel 10 of this embodiment, the 3a-th lens group unit 13, the 3b-th lens group unit 14, and the 3c-th lens group unit 15 are integrated as a third lens group unit that moves forward and backward in the optical axis direction, and the fourth lens group unit 16 is disposed on the inner peripheral side thereof.

The fourth lens group unit 16 is a substantially disk-shaped member disposed on the inner peripheral surface side of the first lens group unit 11, and is disposed on the image plane side of the 3c-th lens group unit 15 in the optical axis direction. As shown in FIGS. 1 and 2, etc., the fourth lens group unit 16 holds the lens L14. The fourth lens group unit 16 moves forward and backward in the optical axis direction when the manual operation ring (zoom ring 19b) is turned, for example. The fourth lens group unit 16 moves integrally with the 3a-th, 3b-th, and 3c-th lens group units 13, 14, and 15, but moves forward and backward in the optical axis direction to perform a focusing operation by autofocus or manual focusing by turning the focus ring 19a.

The fourth lens group unit 16 is a focus lens group that adjusts the focal position, is disposed within the third lens group unit including the 3a-th, 3b-th, and 3c-th lens group units 13, 14, and 15, and is driven back and forth in the optical axis direction integrally with the third lens group unit. The fourth lens group unit 16, together with the third lens group unit, is driven by a focus adjustment actuator (rectilinear actuator).

The rectilinear cylinder 17a is a substantially cylindrical member in which rectilinear grooves are formed in the optical axis direction, and is disposed on the inner peripheral surface side of the first lens group unit 11, as shown in FIGS. 1 and 2, etc.

The cam cylinder 17b is a substantially cylindrical member in which a cam groove is formed along a direction intersecting the optical axis direction, and as shown in FIGS. 1 and 2, etc., is disposed on the inner peripheral surface side of the first lens group unit 11 in a state of being attached to the outer peripheral side of the rectilinear cylinder 17a.

Cam pins of the second lens group unit 12, the 3a-th lens group unit 13, the 3b-th lens group unit 14, the fifth lens group unit 18, etc., mate with the rectilinear grooves of the rectilinear cylinder 17a and the cam grooves of the cam cylinder 17b.

Consequently, the cam pins and the like move along the cam grooves upon receiving a rotational drive force applied from a rotational drive source (not shown), allowing the first to fifth lens group units 11 to 18 to be moved back and forth in the optical axis direction. This allows wide-angle photography, telephoto photography, and the like to be performed by adjusting the distance between the lenses L1 to L16 included in the first to fifth lens group units 11 to 18,.

As shown in FIG. 1, the fifth lens group unit 18 is a substantially disk-shaped resin member that is disposed on the inner peripheral surface side of the rectilinear cylinder 17a and the cam cylinder 17b on the inner peripheral surface side of the first lens group unit 11, and is disposed on the image plane side of the fourth lens group unit 16 in the optical axis direction. As shown in FIGS. 1 and 2, etc., the fifth lens group unit 18 holds the lenses L15 and L16. The fifth lens group unit 18 moves forward and backward in the optical axis direction when the manual operation ring (zoom ring 19b) is turned, for example. Furthermore, the fifth lens group unit 18 has a cam pin 18a (see FIGS. 6 and 8). The cam pin 18a engages with the rectilinear groove in the rectilinear cylinder 17a. This restricts the movement of the fifth lens group unit 18 in the rotational direction, limiting movement in the optical axis direction, as is the case with the first lens group unit 11 and the like.

Also, the cam pin 18a engages with a cam groove in the cam cylinder 17b. Consequently, the position of the fifth lens group unit 18 in the optical axis direction is determined by the position of engagement with the cam groove, and the fifth lens group unit 18 moves to zoom positions such as the retracted position, the WIDE position, or the TELE position when the cam cylinder 17b is turned, as is the case with the first lens group unit 11.

The ring mount base 19 (main body part) is a cylindrical member that constitutes the exterior portion of the lens barrel 10, and the annular focus ring 19a, the zoom ring 19b, and so forth are rotatably attached to the outer peripheral surface.

The focus ring 19a is a cylindrical member that is rotatably attached on the subject side of the outer peripheral surface of the ring mount base 19, and is turned when the focus mechanism is made to function by changing the relative positions of the lenses L1 to L16.

The zoom ring 19b is a cylindrical member that is rotatably attached on the image plane side of the outer peripheral surface of the ring mount base 19, and is turned when a zoom operation is performed by changing the relative positions of the lenses L1 to L16.

As shown in FIG. 1, etc., the lens mount 20 is a substantially circular plate-shaped member that serves as a base to which an adapter (FF adapter 30 or MFTS adapter 40) or the camera body 50 is connected, and is attached on the image plane side of the ring mount base 19.

The FF adapter 30 is, for example, a substantially cylindrical auxiliary member that is removably attached in order to connect the camera body 50, which is equipped with a full-size imaging element, to the lens mount 20 of the lens barrel 10. As shown in FIG. 3A, the FF adapter 30 has a substantially cylindrical main body part 31, a coupling portion 32, and a mounting portion 33.

The coupling portion 32 is a member that is coupled to the lens mount 20 of the lens barrel 10, and is provided on the subject side of the main body part 31. The coupling portion 32 connects the lens barrel 10 and the adapter 30 by bayonet coupling, for example.

The mounting portion 33 is a member that links the mounting portion of the camera body 50 to the FF adapter 30, and is provided on the image plane side of the main body part 31. The mounting portion 33 links the camera body 50 and the adapter 30 by bayonet coupling, for example.

The MFTS adapter 40 is a substantially cylindrical auxiliary member that is removably attached in order to connect, for example, a mirrorless camera body 50 equipped with a Micro Four Thirds-size imaging element to the lens mount 20 of the lens barrel 10. As shown in FIG. 3B, the MFTS adapter 40 has a substantially cylindrical main body part 41, a coupling portion 42, and a mounting portion 43.

The coupling portion 42 is a member that is coupled to the lens mount 20 of the lens barrel 10, and is provided on the subject side of the main body part 41. The coupling portion 42 links the lens barrel 10 and the adapter 40 by bayonet coupling, for example.

The mounting portion 43 is a member that connects the mounting portion of the camera body 50 to the MFTS adapter 40, and is provided on the image plane side of the main body part 41. The mounting portion 43 links the camera body 50 and the adapter 40 by bayonet coupling, for example.

Here, a configuration in which the FF adapter 30 is mounted between the lens barrel 10 and the camera body 50 will be described below with reference to FIGS. 5 and 6.

That is, as shown in FIG. 5, in the lens barrel 10 to which the FF adapter 30 is mounted, at a position on the WIDE side, of the lenses LI to L16 included in the lens barrel 10, the lenses L15 and L16 (fifth lens group unit 18) disposed on the image plane side protrude from the end X1 of the lens barrel 10 toward the image plane side, and are disposed on the inner peripheral surface side of the FF adapter 30. On the other hand, as shown in FIG. 6, at a position on the TELE side, all of the lenses L1 to L16 included in the lens barrel 10 are disposed on the inner peripheral surface side of the lens barrel 10.

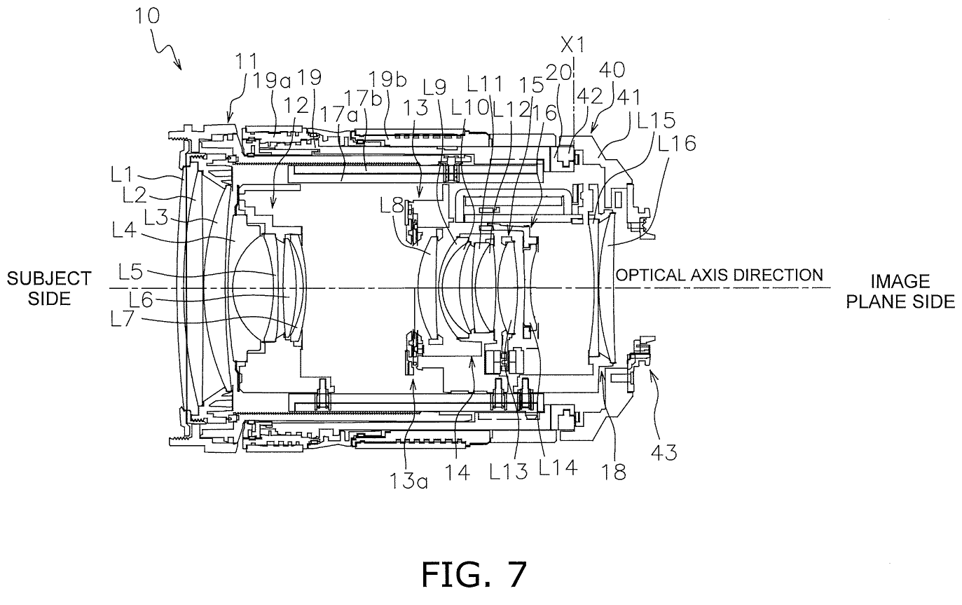

Next, a configuration in which the MFTS adapter 40 is mounted between the lens barrel 10 and the camera body 50 will be described below with reference to FIGS. 7 and 8.

That is, as shown in FIG. 7, in the lens barrel 10 to which the MFTS adapter 40 mounted, at a position on the WIDE side, of the lenses LI to L16 included in the lens barrel 10, the lenses L15 and L16 (fifth lens group unit 18) disposed on the image plane side protrude from the end X1 of the lens barrel 10 toward the image plane side, and are disposed on the inner peripheral surface side of the MFTS adapter 40. On the other hand, as shown in FIG. 8, at a position on the TELE side, all of the lenses L1 to L16 included in the lens barrel 10 are disposed on the inner peripheral surface side of the lens barrel 10.

As discussed above, when the lens barrel 10 of this embodiment is retracted (when not photographing), all of the lenses L1 to L16 are disposed closer to the subject side in the optical axis direction (see FIG. 1), and when photographing, and particularly at a position on the WIDE side, the lenses L15 and L16 disposed closest to the image plane side are disposed so as to protrude from the end X1 of the lens barrel 10 toward the image plane side (see FIGS. 2, 5, and 7).

That is, in the retracted position shown in FIG. 1, compared to the WIDE position shown in FIG. 2, the first lens group unit 11 and the second lens group unit 12 are in the WIDE position, but the third lens group unit (3a-th, 3b-th, and 3c-th lens group units 13, 14, and 15) moves toward the subject side, and therefore the fifth lens group unit 18 is disposed in a space provided on the image plane side of the lens barrel 10.

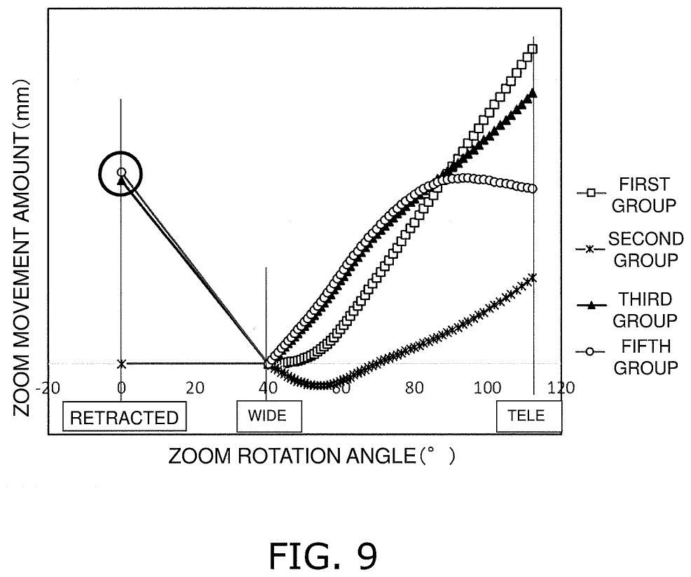

The cam grooves provided to the cam cylinder 17b move the first, second, 3a-th, and fifth lens group units 11, 12, 13, and 18 in the optical axis direction relative to the zoom rotation angle as shown in FIG. 9. More specifically, the cam grooves are designed so that the 3a-th lens group unit 13 and the fifth lens group unit 18 are disposed on the subject side at the retracted position (0°) shown in FIG. 9.

In FIG. 9, the amount of zoom movement is plotted using the WIDE position as the movement origin.

Consequently, the lenses L15 and L16 protruding toward the image plane side are enveloped on the inner peripheral surface side of the adapter (the FF adapter 30 or the MFTS adapter 40), which prevents the lenses L15 and L16 from interfering with the camera body 50.

### Major Features

The lens barrel 10 of this embodiment is used in a state of being mounted to the camera body 50, changes the relative positions of the lenses L1 to L16 between when photography is and is not being performed, and includes the substantially cylindrical ring mount base 19, the plurality of lenses L1 to L16, and the zoom ring 19b. The lenses L1 to L16 are disposed along the optical axis direction. The zoom ring 19b changes the relative positions of the lenses L1 to L16, moves the lenses L1 to L16 so that they are housed inside the ring mount base 19 when not photographing, and moves at least one of the lenses L1 to L16 to a position where the lens protrudes in the optical axis direction from the side of the ring mount base 19 that is mounted to the camera body 50 when photographing.

This allows a given lens barrel 10 to be linked to camera bodies 50 of various specifications by mounting a corresponding adapter (FF adapter 30 or MFTS adapter 40) depending on whether the camera body 50 is a model equipped with a full-size imaging element or one equipped with a Micro Four Thirds system imaging element.

As a result, for camera bodies 50 with different specifications, such as full-size or Micro Four Thirds system, a corresponding adapter (FF adapter 30 or MFTS adapter 40, etc.) can be mounted and connected to the lens barrel 10 without increasing the size in the optical axis direction during photography.

### Other Embodiments

An embodiment of the present disclosure was described above, but the present disclosure is not limited to or by the above embodiment, and various modifications are possible without departing from the gist of the disclosure.

### (A)

In the above embodiment, an example was given in which the zoom ring 19b (manual operation ring) was used as the drive unit that changed the relative positions of the lenses L1 to L16, moved the lenses L1 to L16 so that they were housed inside the ring mount base 19 when retracted (when not photographing), and moved at least one of the lenses L1 to L16 to a position of protruding in the optical axis direction from the side of the ring mount base 19 that was attached to the camera body 50 when photographing. However, the present disclosure is not limited to this.

For example, the configuration may be such that a motor or other such drive unit is used to electrically control the changing of the relative positions of a plurality of lenses, the lenses are moved so that they are housed inside the main body part when not photographing, and when photographing, at least one of the lenses is moved to a position of protruding in the optical axis direction from the side of the main body part that is mounted to the camera body.

### (B)

In the above embodiment, an example was given in which the FF adapter 30 and the MFTS adapter 40 used as an adapter that was mounted between the lens barrel 10 and the camera body 50. However, the present disclosure is not limited to this.

For example, the adapter that is mounted between the lens barrel 10 and the camera body 50 may be something than an FF adapter or an MFTS adapter.

### (C)

In the above embodiment, as shown in FIG. 2, etc., an example was given in which the lenses L15 and L16 (fifth lens group unit 18) disposed on the image plane side in the optical axis direction during photography (during use) were disposed at a position protruding from the end X1 of the lens barrel 10 toward the image plane side. However, the present disclosure is not limited to this.

For example, the lens that protrudes towards the image plane side in the optical axis direction during photography is not limited to lenses included in the fifth lens group unit, and may instead be a lens included in another lens group.

### (D)

In the above embodiment, an example was given in which the number of lenses included in the lens barrel 10 was 16. However, the present disclosure is not limited to this.

For example, the number of lenses included in the lens barrel may be 15 or less, or may be 17 or more.

### Additions

The above description of the embodiments discloses the following techniques.

### Technique 1

The lens barrel according to Technique 1 is:
a lens barrel that is used in a state of being mounted to a camera body, and in which the relative positions of a plurality of lenses are different when photographing and when not photographing, the lens barrel comprising:
a substantially cylindrical main body part;
a plurality of lenses disposed along an optical axis direction; and
a drive unit that changes the relative positions of the plurality of lenses, moves the lenses so as to be housed inside the main body part when not photographing, and moves at least one of the lenses to a position protruding in the optical axis direction from the side where the main body part is mounted to the camera body when photographing.

### Technique 2

The lens barrel according to Technique 2 is:
a lens barrel that is used in a state of being mounted to a camera body, and in which the relative positions of a plurality of lenses are different when photographing and when not photographing, the lens barrel comprising:
a substantially cylindrical main body part;
a plurality of lenses disposed along an optical axis direction; and
a drive unit that changes the relative positions of the plurality of lenses, and moves the lenses so as to be closer to the subject side in the main body part, the length of the main body part in the optical axis direction being invariable when not photographing.

### Technique 3

The lens barrel according to Technique 3 is the lens barrel according to Technique 1 or 2,
further comprising an adapter that is removably mounted between the main body part and the camera body, and in which at least one of the plurality of lenses is inserted on the inner peripheral side when photographing.

### Technique 4

The lens barrel according to Technique 4 is the lens barrel according to Technique 3,
wherein the adapter can be attached to a camera lens system different from the camera lens system of the camera body.

### Technique 5

The lens barrel according to Technique 5 is the lens barrel according to Technique 3,
wherein the adapter can be attached to and removed from the camera body.

### Technique 6

The lens barrel according to Technique 6 is the lens barrel according to any of Techniques 1 to 5,
wherein the drive unit is a substantially annular manual operation ring that is rotatably attached to the outer peripheral surface of the main body part and that changes the relative positions of the plurality of lenses by a rotation operation.

### Technique 7

The lens barrel according to Technique 7 is the lens barrel according to any of Techniques 1 to 6,
wherein the drive unit is a motor that is provided inside the main body part and electrically changes the relative positions of the plurality of lenses.

### Technique 8

The camera according to Technique 8 comprises:
the lens barrel according to any of Techniques 1 to 7; and
the camera body.

### INDUSTRIAL APPLICABILITY

The lens barrel of the present disclosure exhibits the effect that an adapter compatible with camera bodies of different specifications can be mounted without increasing the size in the optical axis direction during photography, and as such can be widely applied to camera systems that include a lens barrel that can be attached to and removed from a camera body.

### REFERENCE SIGNS LIST

10 lens barrel
11 first lens group unit
11a cam pin
12 second lens group unit
12a cam pin
13 3a-th lens group unit
13a aperture unit
13b cam pin
14 3b-th lens group unit
15 3c-th lens group unit
16 fourth lens group unit
17a rectilinear cylinder
17b cam cylinder
18 fifth lens group unit
18a cam pin
19 ring mount base (main body part)
19a focus ring
19b zoom ring (drive unit, manual operation ring)
20 lens mount
30 FF adapter (adapter)
31 main body part
32 coupling portion
33 mounting portion
40 MFTS adapter (adapter)
41 main body part
42 coupling portion
43 mounting portion
50 camera body
L1 to L16 lenses (optical system)
X1 end
X2 protruding portion

What is claimed is:

1. A lens barrel that is used in a state of being mounted to a camera body, and in which relative positions of a plurality of lenses are different when photographing and when not photographing, the lens barrel comprising:
a substantially cylindrical main body part;
a plurality of lenses disposed along an optical axis direction; and
a drive unit configured to change relative positions of the plurality of lenses, move the lenses so as to be housed inside the main body part when not photographing, and move at least one of the lenses to a position protruding in the optical axis direction from a side where the main body part is mounted to the camera body when photographing.

2. A lens barrel that is used in a state of being mounted to a camera body, and in which relative positions of a plurality of lenses are different when photographing and when not photographing, the lens barrel comprising:
a substantially cylindrical main body part;
a plurality of lenses disposed along an optical axis direction; and
a drive unit configured to change the relative positions of the plurality of lenses, and move the lenses so as to be closer to a subject side in the main body part, a length of the main body part in the optical axis direction being invariable when not photographing.

3. The lens barrel according to claim 1, further comprising an adapter that is removably mounted between the main body part and the camera body, and in which at least one of the plurality of lenses is inserted on an inner peripheral side when photographing.

4. The lens barrel according to claim 3,
wherein the adapter can be attached to a camera lens system different from the camera lens system of the camera body.

5. The lens barrel according to claim 3,
wherein the adapter can be attached to and removed from the camera body.

6. The lens barrel according to claim 1,
wherein the drive unit is a substantially annular manual operation ring that is rotatably attached to an outer peripheral surface of the main body part and that is configured to change the relative positions of the plurality of lenses by a rotation operation.

7. The lens barrel according to claim 1,
wherein the drive unit is a motor that is provided inside the main body part and is configured to electrically change the relative positions of the plurality of lenses.

8. A camera, comprising:
the lens barrel according to claim 1; and
the camera body.
